(19) United States
(12) Patent Application Publication
(10) Pub. No.: US 2023/0274534 A1
(43) Pub. Date: Aug. 31, 2023

(54) ANNOTATION REFINEMENT FOR SEGMENTATION OF WHOLE-SLIDE IMAGES IN DIGITAL PATHOLOGY

(71) Applicant: Siemens Healthcare GmbH, Erlangen (DE)

(72) Inventors: Andre AICHERT, Erlangen (DE); Marvin TEICHMANN, Erlangen (DE); Birgi TAMERSOY, Erlangen (DE); Martin KRAUS, Fuerth (DE); Arnaud Arindra ADIYOSO, Nuernberg (DE)

(73) Assignee: Siemens Healthcare GmbH, Erlangen (DE)

(21) Appl. No.: 18/173,330

(22) Filed: Feb. 23, 2023

(30) Foreign Application Priority Data
Feb. 25, 2022 (EP) 22158794.2

(51) Int. Cl. G06V 10/774; G06T 7/11; G06T 7/00; G06V 20/70; G06V 10/77; G06V 10/56; G06V 10/26; G06V 10/764

(52) U.S. Cl. CPC G06V 10/774; G06T 7/11; G06T 7/0012; G06V 20/70; G06V 10/7715; G06V 10/56; G06V 10/26; G06V 10/764; G06T 2207/20021; G06T 2207/20081; G06T 2207/30096; G06V 2201/03

(57) ABSTRACT

Various disclosed examples pertain to digital pathology, more specifically to training of a segmentation algorithm for segmenting whole-slide images depicting tissue of multiple types. An initial annotation of a whole-slide image is refined to yield a refined annotation based on which parameters of the segmentation algorithm can be set. Techniques of patch-wise weak supervision can be employed for such refinement.

### CROSS-REFERENCE TO RELATED APPLICATION(S)

The present application claims priority under 35 U.S.C. § 119 to European Patent Application No. 22158794.2, filed Feb. 25, 2022, the entire contents of which are incorporated herein by reference.

### FIELD

Various examples of the disclosure pertain to determining a ground truth for when performing a training of a machine-learning algorithm in the context of digital pathology. More specifically, various examples pertain to determining an annotation of a whole slide image depicting tissue of multiple types and using the annotation for training of a segmentation algorithm.

### BACKGROUND

In histopathology, a tissue sample of a patient is inspected to study a manifestation of a disease such as cancer.

Conventionally, a practitioner can manually inspect the tissue samples—e.g., stained using a chemical stain—using a microscope. In further detail, thin tissue slides are prepared by sectioning a tissue sample. Then, an image is acquired depicting the tissue slide.

Recently, algorithmic analysis of tissue samples has become possible. This is referred to as digital pathology. Reference techniques of digital pathology use Convolutional Neural Networks (CNNs) as an example of machine-learning (ML) algorithms. Such techniques are described in: Karen Simonyan and Andrew Zisserman. Very deep convolutional networks for large-scale image recognition. arXiv preprint arXiv:1409.1556, 2014. Such techniques are further described in: Kaiming He, Xiangyu Zhang, Shaoqing Ren, and Jian Sun. Deep residual learning for image recognition. CoRR, abs/1512.03385, 2015. Such techniques are further described in: Mingxing Tan and Quoc V Le. Efficientnet: Rethinking model scaling for convolutional neural networks. arXiv preprint arXiv:1905.11946, 2019. Such techniques are further described in: Ilija Radosavovic, Raj Prateek Kosaraju, Ross Girshick, Kaiming He, and Piotr Dollar. Designing network design spaces. In Proceedings of the IEEE/CVF Conference on Computer Vision and Pattern Recognition, pages 10428-10436, 2020.

Oftentimes, digital pathology requires processing large images, e.g., Whole Slide Tissue Images (WSI). A WSI depicts a microscopically magnified tissue slide of macroscopic scale, e.g., centimeters; thus, the WSI can include a large number of pixels. WSIs typically come at a size of tens of thousands of pixels in each dimension. Tissue slides either from biopsies or resected tumor tissue are prepared on glass slides, which can be scanned by a digital microscope in high resolution (gigapixels) and high throughput. Because of their size and number, WSI is especially well-suited for data-hungry ML algorithms. They can be processed by an ML algorithm as a whole or on the basis of small image patches cut out from the large images.

It has been found that training ML algorithms to process WSIs can be time consuming and/or error prone. The sheer amount of image data oftentimes requires large amounts of expensive annotations for supervised learning. Annotations—including ground-truth labels for the training process—are expensive and time consuming and pathology requires specific solutions with training and validation data for a myriad of specific tissue or cancer types, organs, resection versus biopsy and possibly parameters of the preparation of the physical tissue sample (fixation, dies, slicing etc.). For example, for a standard tumor recognition task which is used as intermediate representation in many ML-based pathology systems, the pathologist is required to provide local, ideally pixelwise ground-truth labels for the training process of the ML algorithm. In addition, obtaining high-resolution ground-truth labels can be challenging since there are many fine structures and areas which are hard to categorize, even for a domain expert.

There are several approaches to address high cost and lack of annotations. First of all, not all samples of training data are equally informative. Annotation frequent and/or simple-to-detect samples may not contribute in the same amount to better performance as annotation of rare and/or difficult-to-detect samples of training data. A good set of samples is diverse across the various types that are to be detected by the ML algorithm and covers the whole distribution of possible samples. Active learning is an interactive process, where the added value of having a certain sample labeled is explicitly modelled, thus presenting the annotator with a careful selection of valuable samples. Visual similarity can be assessed in an unsupervised manner to maximize the diversity of samples. Uncertainty can be used as an indicator that more data of a certain kind is needed. Most active learning approaches use the latter or a combination of the two criteria to maximize the training performance while minimizing the amount of labeled data. An example of this process that was also applied to WSI can be found in Yang, Lin, et al. “Suggestive annotation: A deep active learning framework for biomedical image segmentation.” International conference on medical image computing and computer-assisted intervention. Springer, Cham, 2017. An example that applies a one-shot strategy and therefore mostly relies on the first criterion can be found in Zheng, Hao, et al. “Biomedical image segmentation via representative annotation.” Proceedings of the AAAI Conference on Artificial Intelligence. Vol. 33. No. 01. 2019.

### SUMMARY

The inventors have identified a need for advanced techniques of training ML algorithms to process WSIs. More specifically, for example, the inventors have identified a need for training ML algorithms segmenting WSIs to detect different tissue types.

At least these needs are met by the features of embodiments of the present invention and/or the independent claims. The features of the dependent claims further define embodiments.

Various techniques are based on the finding that accuracy and level of detail required in an annotation protocol for determining an annotation of a WSI can have a significant impact on the effort required for the annotated to prepare the annotation. Techniques are disclosed that facilitate accurate training of ML algorithms while nonetheless annotations of WSIs can have a comparably low level of detail, thus facilitating a fast yet robust annotation protocol

A computer-implemented method of training a segmentation algorithm for digital pathology as disclosed. The segmentation algorithm segmenting a whole-slide image. The whole-slide image depicts tissue of multiple types. Said segmenting is in accordance with the multiple types. The computer-implemented method includes obtaining the whole-slide image and obtaining a first annotation of at least a part of the whole-slide image. The first annotation is for the multiple types. The first annotation has a first level of detail. Based on a first annotation, the computer-implemented method further includes determining a second annotation of the whole-slide image. Also, the second annotation is for the multiple types. The second annotation has a second level of detail which is higher than the first level of detail. The computer-implemented method also includes setting parameters of the segmentation algorithm based on a second annotation.

The first annotation can include multiple labels. Each label may be associated with a respective region in the whole-slide image. Each label may be indicative of a given type of the tissue. For instance, each label may be indicative of a majority type of the tissue in that region. There may be minority types of tissue also present in the respective region, at least to some certain extent.

The second annotation can include multiple labels. Each label may be associated with a respective region in the whole-slide image. Each label may be indicative of a given type of the tissue. For instance, each label may be indicative of a majority type of the tissue in that region. There may be minority types of tissue also present in the respective region, at least to some certain extent.

The second annotation can thus serve as ground truth for setting parameters of the segmentation algorithm. The whole-slide image and the annotations can constitute training data for the training of the segmentation algorithm.

A segmentation result of the segmentation algorithm will thus yield multiple segments/regions of the whole-slide image that are associated with different types of tissue. The segmentation result is at the second level of detail, since the segmentation algorithm is trained based on the second annotation that has the second level of detail.

Since the second annotation has a higher level of detail, the second annotation can be referred to as a “refined annotation”.

Said setting of the parameters of the segmentation algorithm can benefit from such higher level of detail of the second annotation. The segmentation algorithm can thereby be trained to deliver segmentation results at the second level of detail.

The level of detail could pertain to a spatial resolution with which labels of the respective annotation resolve different types of the tissue. The level of detail can pertain to the level of accuracy with which the respective annotation discriminates between different types of the tissue. The level of detail of an annotation could pertain to the spatial resolution of contours of respective regions that have assigned there to a respective label that identifies a specific type of a tissue. The level of detail of an annotation could pertain to a maximum ratio or quota of minority types to be included in a given region that has a label assigned thereto indicative of a majority type. The level of detail of an annotation could pertain to a maximum size threshold for which instances of a minority type (e.g., tissue fractions that are associated with a type that is different to the type of the label assigned to the region within which the respective tissue fractions are located) are allowed to exist within a given region to which a label of a majority type is assigned).

According to examples, a training of a classification algorithm is performed based on the first annotation. The classification algorithm is configured to classify image regions of the whole-slide image in accordance with the types. Upon said performing of the further training, the classification algorithm can be used to determine the second annotation.

In other words, the classification algorithm can output labels for the image regions, the labels being indicative of the types of the tissue.

For instance, the image regions could be implemented by patches of a patch grid. The classification algorithm can, accordingly, output, for each patch of the patch grid, a respective label, this label than being indicative of one of the types of the tissue.

Depending on the size of the patches, accordingly, the level of detail of the classification result of the classification algorithm can be comparatively low. Thus, the classification result may not be suited, in all scenarios, to serve as a basis for the setting of the parameters of the segmentation algorithm so that the segmentation algorithm offers a higher level of detail.

According to some examples, a respective class activation map of the classification algorithm can be determined for each one of the image regions of the whole-slide image. Then, the second annotation can be determined based on the class activation map. The class activation map can specify, for each class that can be classified by the classification algorithm—i.e., in other words for each type of the tissue—a relative contribution of specific fractions of each image region. Thus, the class activation map can provide for a localization of features that favor a certain classification result within the respective image region, e.g., within the respective patch. Hence, the class activation map offers a higher level of detail if compared to the classification result.

For instance, it would be possible that labels obtained by the class activation map for certain fractions of each image region are used as ground truth for setting parameters of the segmentation algorithm. In other examples, such level of detail offered by the class activation map may still not be sufficiently large. In such examples, it would be possible to combine image-level features of the whole-slide image with the class activation maps for each image region.

Specifically, it would be possible to determine, based on features of the whole-slide image, a partitioning of the whole-slide image and then perform a pooling operation of the values of the class activation map, for each type of the tissue/for each class, across these partitions of the partitioning. Based on the result of the pooling operation, it is then possible to determine, for each partition of the partitioning, a respective label that is indicative of a particular type of the tissue. These labels can then be used for setting the parameters of the segmentation algorithm. The level of detail of the partitioning of the whole-slide image thus governs the level of detail of the labels that are obtained in such manner; depending on the particular choice of the partitioning algorithm, a high level of detail is possible. At the same time, the accuracy with which the labels are determined can also be high, due to the use of the results from the classification algorithm.

A computer program or a computer-program product or a computer-readable storage medium includes program code. The program code can be loaded and executed by a processor. Upon loading and executing the program code, the processor performs a method of training a segmentation algorithm for digital pathology as disclosed. The segmentation algorithm is configured to segment a whole-slide image. The whole-slide image depicts tissue of multiple types. The computer-implemented method includes obtaining the whole-slide image and obtaining a first annotation of at least a part of the whole-slide image. The first annotation is for the multiple types. The first annotation has a first level of detail. Based on a first annotation, the computer-implemented method further includes determining a second annotation of the whole-slide image. Also, the second annotation is for the multiple types. The second annotation has a second level of detail which is higher than the first level of detail. The computer-implemented method also includes setting parameters of the segmentation algorithm based on a second annotation.

A device includes a processor and a memory. The processor can load and execute program code from the memory. Upon loading and executing the program code, the processor is configured to perform a method of training a segmentation algorithm for digital pathology as disclosed. The segmentation algorithm is configured to segment a whole-slide image. The whole-slide image depicts tissue of multiple types. The computer-implemented method includes obtaining the whole-slide image and obtaining a first annotation of at least a part of the whole-slide image. The first annotation is for the multiple types. The first annotation has a first level of detail. Based on a first annotation, the computer-implemented method further includes determining a second annotation of the whole-slide image. Also, the second annotation is for the multiple types. The second annotation has a second level of detail which is higher than the first level of detail. The computer-implemented method also includes setting parameters of the segmentation algorithm based on a second annotation.

It is to be understood that the features mentioned above and those yet to be explained below may be used not only in the respective combinations indicated, but also in other combinations or in isolation without departing from the scope of the present invention.

### BRIEF DESCRIPTION OF THE DRAWINGS

FIG. 1 schematically illustrates a device according to various examples.

FIG. 2 is a flowchart of a method according to various examples.

FIG. 3 is a flowchart of a method according to various examples.

FIG. 4 schematically illustrates a WSI according to various examples.

FIG. 5 schematically illustrates an initial annotation obtained from a manual annotation process and having a first level of detail according to various examples.

FIG. 6 is a flowchart of a method according to various examples.

FIG. 7 schematically illustrates a grid of patches of a WSI according to various examples.

FIG. 8 schematically illustrates patch-wise classification results of a classification algorithm according to various examples.

FIG. 9 schematically illustrates a class activation map of the classification algorithm according to various examples.

FIG. 10 schematically illustrates a classification result of a classification algorithm according to various examples.

FIG. 11 schematically illustrates super-pixels of a WSI according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the present invention will be described in detail with reference to the accompanying drawings. It is to be understood that the following description of embodiments is not to be taken in a limiting sense. The scope of the present invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of digital pathology are described. Input images depicting tissue samples can be processed using an ML algorithm. The ML algorithm can receive an input image and process the input image. An example ML algorithm is a neural network algorithm (NN).

As a general rule, the NN includes multiple layers. The input to a first layer is the input image. Each layer can apply one or more mathematical operations on the input values, e.g., convolutions, nonlinear excitations, pooling operations, to give just a few examples. The input to a layer can be formed by the output of a preceding layer (feed-forward). Feedback of values or skip-connection skipping layers are possible.

The NN for digital pathology can infer at least one semantic histopathology feature. The at least one semantic histopathology feature can describe whether the tissues sample is a manifestation of a disease. It would be possible to segment tissue in an input image, according to various types. Healthy and/or unhealthy tissue may be detected and specifically localized. It would be possible to rate an organ fitness of an organ anatomy in view of tumor growth. A tumor may be graded in accordance with a predefined scale, e.g., to determine a severity. Example semantic histopathology features that could be inferred can be selected from the group consisting of: Gleason scoring, cancer grade/cancer stage estimation, clinical pathway prediction, sub-tumor classification, metastasis evaluation, microsatellite instability (MSI) or stability. For example, a cancer grade can be in accordance with a predefined grading system/scale. Examples would include the Bloom-Richardson score or TNM classification of malignant tumors. Classification systems are available for brain tumors, breast tumors, prostate cancer (Gleason scoring), and other kind of tumors.

The input image received by the ML algorithm could have a size of at least 4.000×4.000 pixels, or at least 10.000×10.000 pixels, or at least 1E6×1E6 pixels. The input image could be a WSI. The input image could be acquired using optical microscopy. The tissue slide for which the input image is acquired can be stained using a chemical stain. Illumination can be used to generate a respective contrast.

Various examples disclosed herein are described in the practical example of an ML algorithm that segments a WSI (ML segmentation algorithm). This means that image regions of the WSI that include tissue of a certain type are delimited by a respective segmentation mask defining the segments. Multiple segments can be determined. Different segments can be associated with tissue of different types.

As a general rule, depending on the scenario, different implementations of such types of tissue to be detected by the ML algorithm are conceivable. For instance, the ML algorithm may segment a WSI to distinguish between a type “cancerous” and another type of non-cancerous” tissue. The other examples possible. For instance, it would be possible to segment a WSI to determine tissue that is infiltrated by immune cells, as a respective type. It would be possible to segment sections of the WSI that do not show tissue altogether, i.e., “no tissue” segments. The particular types of the tissue to be distinguished by the ML algorithm depend on the training of the ML algorithm.

Hereinafter, details of the training of the ML segmentation algorithm will be disclosed. More specifically, techniques are disclosed that facilitate determining a ground truth used for training of the ML segmentation algorithm. Ground-truth labels of an annotation can be used when setting weights of the ML segmentation algorithm.

An annotation can serve as ground truth for the training of the ML segmentation algorithm. The annotation can include ground-truth labels (or, simply, labels) that specify the type of the tissue for certain regions of the WSI. During the training of the ML segmentation algorithm, based on a loss function that compares the output of the ML segmentation algorithm with the labels of the annotation, the parameters of the ML segmentation algorithm can be adjusted so as to minimize a difference between the output of the ML segmentation algorithm and the labels of the annotation. Various training techniques are generally known, e.g., backpropagation using a gradient-descent type of optimization, so that further techniques of the training itself are not required to be described in this context.

Due to the size of WSIs, determining an annotation of the WSI for training a ML segmentation algorithm can be a difficult task. Specifically, to determine annotations at a high level of detail, e.g., pixel level, is not practical due to the size of the WSI.

Various examples disclosed herein are based on the finding that the task of generating a ground truth for training of an ML segmentation algorithm that can operate based on WSIs can be implemented based on a concept that may be referred to as “patch-wise weak supervision”. The general concept of weak supervision is known in other contexts than digital pathology; e.g., image-level annotations are known to serve as a starting point for training a in ML segmentation algorithm to segment the pixels contributing to the class defined by the image-level annotation. To give a concrete example, an image (e.g., a photography) may either depict a cat or a dog; a respective information may be available as part of an annotation. The annotation may not resolve the particular parts of the image that depict the cat or the dog. In other words, the annotation may be a 1-bit annotation, where, e.g., “1” identifies that a cat is depicted while “0” identifies that a dog is depicted. Then, using techniques of “weak supervision”, and ML segmentation algorithm may be trained to segment pixels that either show the cat or the dog, taking this 1-bit annotation as ground truth.

An example “weak supervision” of training a segmentation algorithm is disclosed in Wang, Xi, et al. “Weakly supervised deep learning for whole slide lung cancer image analysis.” IEEE transactions on cybernetics 50.9 (2019): 3950-3962. Also see Izadyyazdanabadi, Mohammadhassan, et al. “Weakly-supervised learning-based feature localization for confocal laser endomicroscopy glioma images.” International Conference on Medical Image Computing and Computer-Assisted Intervention. Springer, Cham, 2018.

On the other hand, WSIs include a significant higher amount of information if compared to such natural images where techniques of weak supervision of training of a segmentation algorithm have been previously employed. This means that, e.g., different types of tissue can occur at different areas of the WSI, such that it is not possible to assign a global label (e.g., cancerous or non-cancerous tissue) to the WSI.

According to various examples, it is possible to refine and annotation, i.e., obtain a first annotation that has a first level of detail (initial annotation) and, based on this initial annotation, determine a second annotation (refined annotation) of the WSI that has a second level of detail which is higher than the first level of detail.

By such techniques, it is possible to reduce the efforts for the annotation process that is used to determine the initial annotation. In other words, the ground truth for performing the training of the segmentation algorithm can be determined comparably fast.

As a general rule, the term “level of detail” as used herein can pertain to a spatial resolution with which borders of labels of an annotation are defined. For instance, at a low level of detail a edge points of a polyline delimitating areas associated with a given label may be spaced apart by a larger distance than for a high level of detail.

Alternatively or additionally, “level of detail” could pertain to a size threshold below which structures are neglected. For instance, considering an area that is associated with the label “non-cancerous tissue” may include small cancerous structures below a size threshold.

Alternatively or additionally, “level of detail” could pertain to a maximum count of structures/tissue fractions of minority type in an area; e.g., considering an area that is associated with the label “non-cancerous tissue”, such area may include cancerous tissue instances up to a certain quota.

Various techniques are based on the finding that such refinement of the initial annotation to obtain the refined annotation having a higher level of detail is, in particular, possible if one or more constraints are observed in the annotation protocol used for determining the initial annotation. In other words, the refinement is facilitated by a ruleset to be obeyed by the annotator, e.g., the pathologist.

Some examples for such these constraints for the first annotation are summarized below in TAB. 1.

TABLE 1
Various examples of constraints of the annotation
that is determined in a manual annotation process.

| | Brief | |
|---|---|---|
| | description | Example details |
| I | Exclusive | The labels can annotate that a certain |
| | labels | region of the WSI is associated with a |
| | | certain type of the tissue. The |
| | | annotation can observe the constraint that |
| | | there may not be any regions of the WSI |
| | | that are associated with multiple types |
| | | of the tissue in the annotation. |
| II | Tight | Tight labels are labels for which the |
| | labels | borders do not strike parts of other |
| | | larger tissue areas and should not in- |
| | | clude structures that are larger than |
| | | said size of any other tissue. |
| III | Threshold | The idea is to define a rough threshold |
| | of scale | of scale beyond which the annotator does |
| | | not “care”. E.g., a region of tumor cells |
| | | may have immune cells, blood vessels, |
| | | connective tissue etc. throughout. While |
| | | these cells are not strictly cancer |
| | | cells, they shall be ignored by the |
| | | annotator up to a defined size. |
| | | More generally, any given region of the |
| | | WSI having a label of the first annotation |
| | | that is associated with a first type |
| | | shall not include other types beyond a |
| | | predetermined quota and/or larger than a |
| | | predetermined size threshold. |
| | | Thus, an initial level of detail is |
| | | guaranteed to be smaller than a |
| | | threshold of scale. |

Using such constraints as in TAB. 1 helps to facilitate an efficient annotation process. For instance, by obeying the constraint listed in TAB. 1: example III, i.e., a certain scale threshold, annotation can be implemented comparably fast due the associated low level of detail. This is because the different labels can cover large sections of the WSI where at least up to a certain level of detail only tissue of a given type is present; tissue of other types may also be present, as long as the respective quota is not exceeded and/or the tissue size of the respective instances of the tissue of the other types does not exceed the threshold of scale.

Furthermore, by using such techniques, it is possible that the initial annotation is restricted to a fraction of the WSI. The refined annotation that is determined based on the initial annotation can nonetheless cover the entire WSI. Thus, a partial initial annotation can be extended to cover the entire WSI. Such techniques are based on the finding that it is sometimes better to determine the annotation for a few examples, e.g., thereby covering different WSIs, rather than annotating everything in only a single or a few WSIs.

As a general rule, various techniques are conceivable for determining the refined annotation based on the initial annotation. According to various examples, it would be possible to employ patch-wise weak supervision. There are various techniques known in the art to implement image-level weak supervision. It would be possible to use such techniques that are generally known in the art to operate on image level to operate on patch level. Specifically, the overall WSI can be broken down into multiple patches. It would then be possible to implement the respective weak supervision for determining the refined annotation based on the label provided by the initial annotation at that respective patch.

For instance, based on the initial annotation, a training of a classification algorithm may be performed. The classification algorithm can be configured to classify image regions, e.g., patches, of the WSI in accordance with the types indicated by the initial annotation. I.e., classes of the classification result correspond to types to-be-segmented by the ML segmentation algorithm. Then, upon said performing of the training of the classification algorithm, the classification algorithm can be used to determine the refined annotation.

Here, in one technique, a class activation map (CAM) of the classification algorithm may be determined for the image regions, e.g., the patches, of the WSI. Then, the refined annotation can be determined based on the CAM.

It would be possible to employ a CNN as classification algorithm. For instance, ResNet-18 may be used, see Ayyachamy, Swarnambiga, et al. “Medical image retrieval using Resnet-18.” Medical Imaging 2019: Imaging Informatics for Healthcare, Research, and Applications. Vol. 10954. International Society for Optics and Photonics, 2019. A VGG-16 or VGG-19 CNN could be used, see: Mateen, Muhammad, et al. “Fundus image classification using VGG-19 architecture with PCA and SVD.” Symmetry 11.1 (2019): 1; or Kaur, Taranjit, and Tapan Kumar Gandhi. “Automated brain image classification based on VGG-16 and transfer learning.” 2019 International Conference on Information Technology (ICIT). IEEE, 2019.

Typically, in such architectures of a CNN, a fully connected layer is the output layer, preceded by a pooling layer. The pooling layer is preceded by multiple convolutional layers. There may be skip connections. The CAM may be the input feature map to the pooling layer preceding the fully-connected layer. Accordingly, the CAM typically has a comparably higher level of detail if compared to the patch-wise classification result. The CAM can have a higher level of detail if compared with the initial annotation.

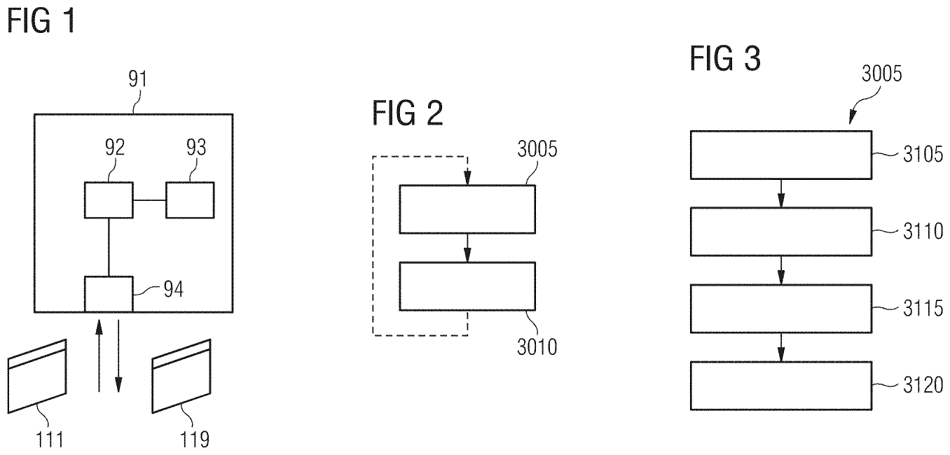

FIG. 1 schematically illustrates a device 91 according to various examples. The device 91 includes a processor 92 that is coupled to a memory 93. The processor 92 can load program code from the memory 93. The processor 92 can execute the program code. The processor 92 can also communicate with other devices and/or databases via an interface 94. For instance, the processor 92 could receive a WSI 111 via the interface 94 for subsequent processing of the WSI. The processor 92 could output semantic information 119 associated with the WSI 111 and obtained from said processing of the WSI via the interface 94. The semantic information 119 could, e.g., include a segmentation result of an ML segmentation algorithm that has been previously trained. Based on such segmentation result, tumor-type tissue could be detected in a WSI.

The processor 92, upon loading and executing the program code, could perform techniques as described herein, e.g.: training of an ML algorithm; performing an annotation process for determining annotations of a WSI; determining a ground truth for a training of an ML algorithm; refining an annotation; setting parameters of a NN, e.g., using backpropagation or another training optimization minimizing a loss value of a loss function; performing techniques of weakly supervised segmentation; inferring semantic features based on WSIs without ground truth being available; etc.

FIG. 2 is a flowchart of a method according to various examples. For instance, the method according to FIG. 2 could be executed by a processor upon loading program code from a memory. For example, the method according to FIG. 2 could be executed by the processor 92 of the device 91 upon loading program code from the memory 93 and upon executing the program code.

At box 3005, and ML segmentation algorithm for digital pathology is trained. This includes setting parameters of the ML segmentation algorithm. Backpropagation can be used. The parameters are set based on ground truth. The training at box 3005 can also include obtaining the ground truth. For instance, an initial annotation of a WSI can be obtained and refined, to obtain a refined annotation based on which parameters are then set. An annotation process can be executed to obtain the initial annotation. Techniques of patch-wise weakly supervised training can be used in order to determine the refined annotation.

At box 3010, the trained ML segmentation algorithm is used for inference tasks as part of digital pathology. This means that one or more further WSIs may be obtained. Then, these one or more further WSIs may be input to the ML segmentation algorithm to thereby obtain segmentation results. Ground truth may not be available for the one or more further WSIs. Based on these segmentation results, it would be possible to detect tumor-type tissue in the one or more further WSIs.

It would be possible to execute a re-training of the ML segmentation algorithm from time to time, as indicated by the dashed arrow in FIG. 2.

FIG. 3 is a flowchart of a method according to various examples. For instance, the method of FIG. 3 may be executed by a processor such as the processor 92 of the device 91 according to FIG. 1. The method of FIG. 3 pertains to training and ML segmentation algorithm for digital pathology that operates based on WSIs. As such, the method of FIG. 3 can implement box 3005 of the method according to FIG. 2.

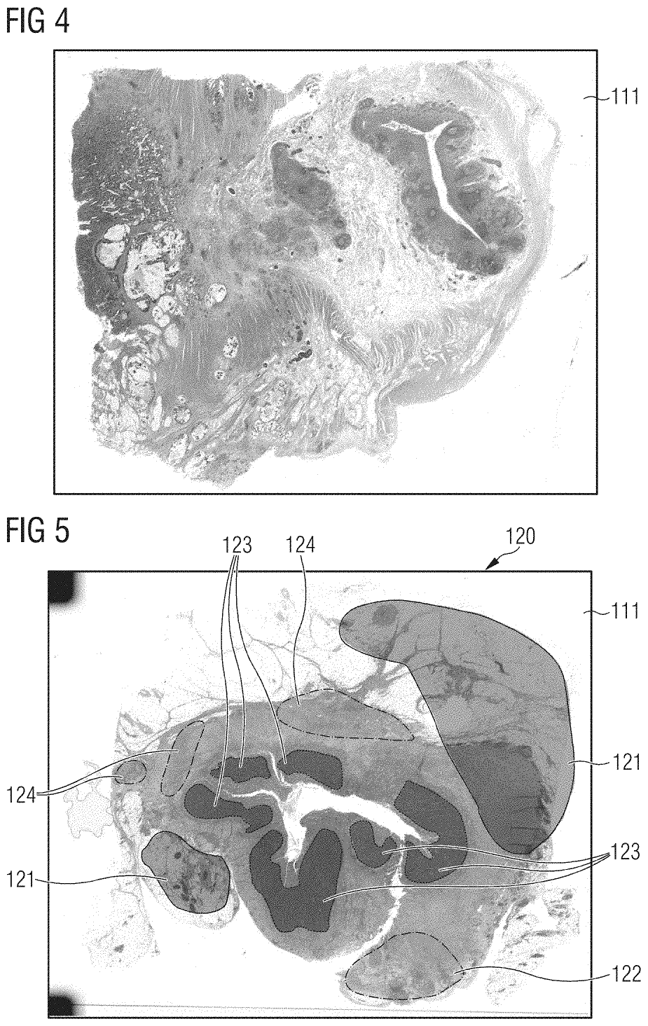

At box 3105, a WSI is obtained (cf. FIG. 4, where an example WSI 111 is shown). For example, the WSI may be loaded from a picture archiving system or another database. The WSI may be acquired using a microscope, e.g., in a laboratory process. The WSI may be acquired using various imaging modalities, e.g., fluorescence of stained tissue samples or tissue slides, etc.

At box 3110, an initial annotation (first annotation) of at least a part of the WSI is obtained (cf. FIG. 5, where the annotation 120 including labels 121-124 for different types of tissue is shown for the WSI 111 of FIG. 4). The initial annotation is for multiple tissue types, i.e., defines labels for each type. The labels can pertain to regions that are delineated by polylines.

The initial annotation has a first level of detail.

For instance, the initial annotation may be obtained from an annotation process that interacts with a user. For instance, the initial annotation may obey one or more constraints such as those constraints as listed in TAB. 1.

It would be possible that the initial annotation only covers a fraction of the overall WSI.

The first level of detail may pertain to a certain accuracy with which the initial annotation is determined. For instance, the initial level of detail may specify a spatial resolution of boundaries of regions associated with a common label. For instance, these boundaries may not be specified with the resolution on pixel level. For instance, the initial level of detail may allow for a certain quota and/or for certain small-sized tissue fractions or segments (i.e., pieces of tissue) of deviating type, i.e., minority types within an area of the region that is associated with a majority type.

Then, at box 3115, a refined annotation of the WSI is determined based on the initial annotation. The refined annotation is also for the multiple types of the tissue. The refined annotation has a second level of detail that is higher than the first level of detail.

For instance, at the second level of detail, a size threshold and/or a quota of minority type instances may be smaller than for the first level of detail.

At box 3120, parameters of the ML segmentation algorithm can be set based on the refined annotation is obtained from box 3115. The refined annotation is obtained from box 3115 can thus serve as the ground truth used for the training process of the ML segmentation algorithm.

Next, details with respect to an example implementation of box 3115 will be explained.

Box 3115 may employ techniques of patch-wise weak supervision of a training of a respective ML algorithm that is used to determine the refined annotation. I.e., it is possible to determine a grid of patches, e.g., a Cartesian grid of patches that all have the same size.

The size of the patches can correlate with size thresholds used in connection with constraints for the first annotation. For instance, where a level of detail is defined on a certain length scale, then the size of the patches can have the same length in accordance with the length scale. To give a concrete example, each such patch is then guaranteed to contain enough relevant tissue for that label even if there are also tissue of other types present, e.g., immune cells, blood vessels, connective tissue etc. present in that patch.

For instance, for each patch, a technique that is based on the general disclosure of Izadyyazdanabadi, Mohammadhassan, et al. “Weakly-supervised learning-based feature localization for confocal laser endomicroscopy glioma images.” International Conference on Medical Image Computing and Computer-Assisted Intervention. Springer, Cham, 2018 could be employed. It would be possible to use a technique as described generally in Wang, Xi, et al. “Weakly supervised deep learning for whole slide lung cancer image analysis.” IEEE transactions on cybernetics 50.9 (2019): 3950-3962.

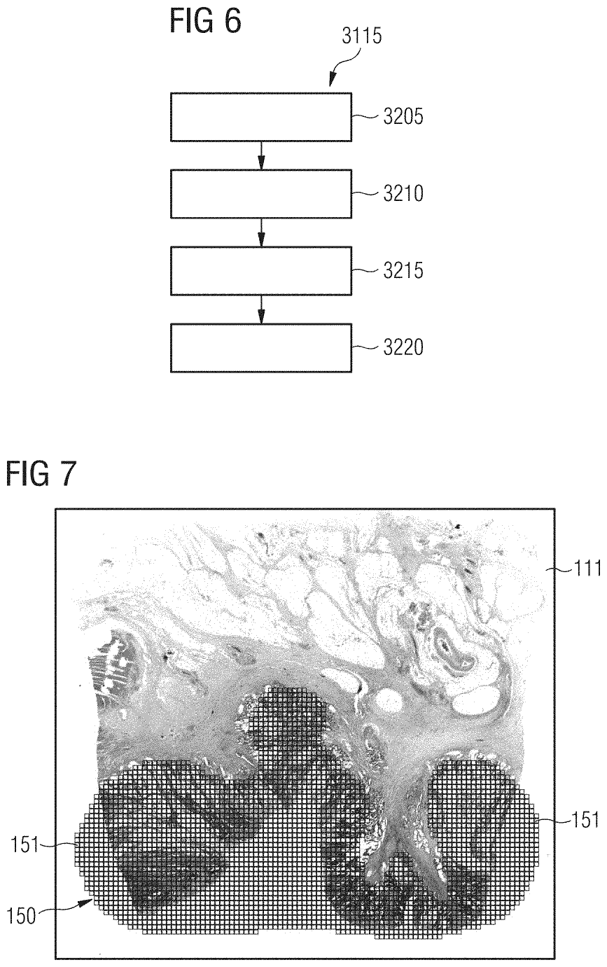

Next, a concrete implementation of box 3115 will be disclosed in connection with FIG. 6.

FIG. 6 is a flowchart of a method according to various examples. The method of FIG. 6 generally pertains to refining an annotation that has a first level of detail, to thereby obtain a further annotation that has a second level of detail which is higher than the first level of detail. The initial annotation can be used to determine the refined annotation. The method of FIG. 6 thus corresponds to obtaining ground truth for a training process for setting parameters of an ML algorithm, e.g., and ML segmentation algorithm to operate based on WSIs for digital pathology. The method of FIG. 6 can, in particular, employs techniques that pertain to patch-based weak supervision of training an ML segmentation algorithm. The method of FIG. 6 can implement box 3115 of the method of FIG. 3.

At box 3205, based on the initial annotation, a training of a classification algorithm is executed. The classification algorithm is configured to classify image regions of the WSI in accordance with different types of tissue. For instance, these image regions could be implemented by patches of a patch grid.

Referring to FIG. 7, there is illustrated an example grid 150 of patches 151 for the WSI 111 that is also depicted in FIG. 4. These patches 151 have a side length that equates to a size threshold below which minority type instances need not to be considered by the annotator in the annotation process, cf. TAB. 1, example III.

To give an example, FIG. 7 illustrates patches 151 that are associated with the labels of the initial annotation pertaining to “tumor cells” label 123 and “no tumor cells” label 122 and “healty tissue” label 121.

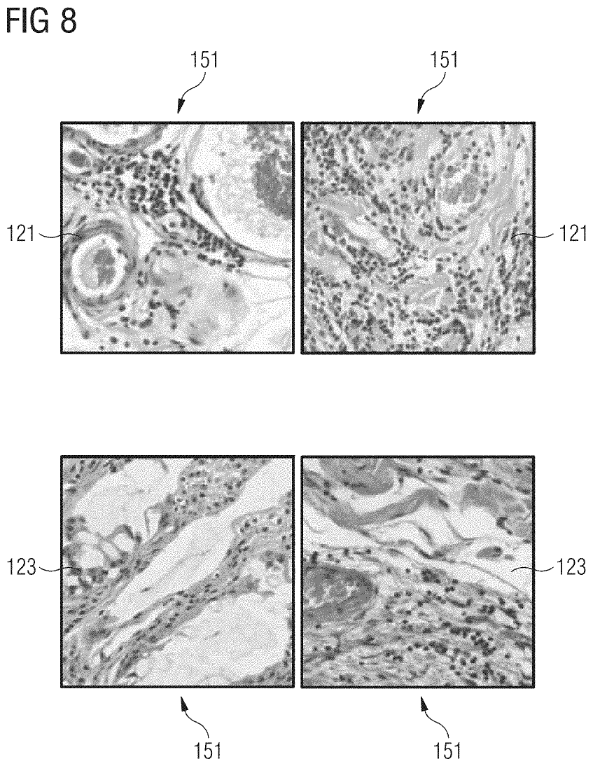

Now, again referring to FIG. 6, at box 3210, a CAM of the classification algorithm is determined for these image regions, e.g., the patches, of the WSI (cf. FIG. 8 where a CAM (CAM) 212 is shown for the WSI 111 that is also depicted in FIG. 4).

A CAM provides discriminative regions from a CNN, each region being associated with a specific class. The CAM identifies which regions of a patch contribute to the overall classification result of that patch.

This CAM can have a certain level of detail that is smaller than the intended level of detail of the refined annotation. For instance, the class activation map can have a comparably low level of detail, e.g., can have a comparably low spatial resolution. The spatial resolution of the class activation map can, in particular, stay behind the intended level of detail for the refined annotation. Thus, hereinafter, techniques will be described which facilitate increasing the level of detail beyond the inherent level of detail of the class activation map, to thereby obtain the refined annotation at the higher level of detail.

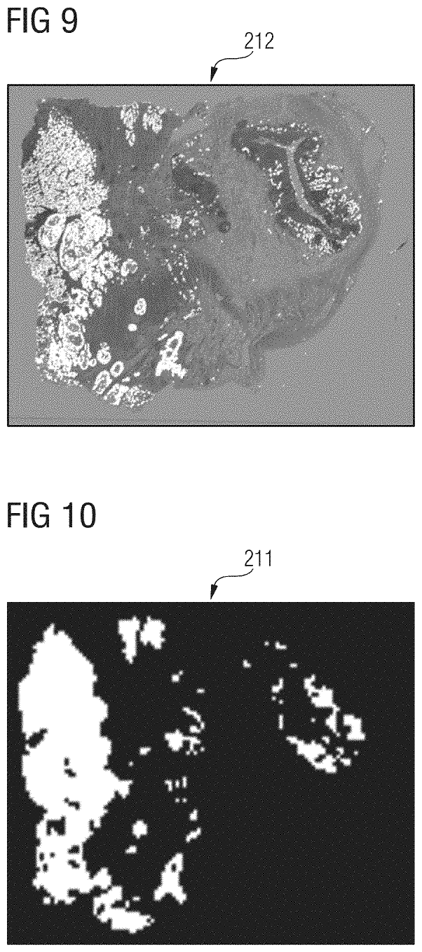

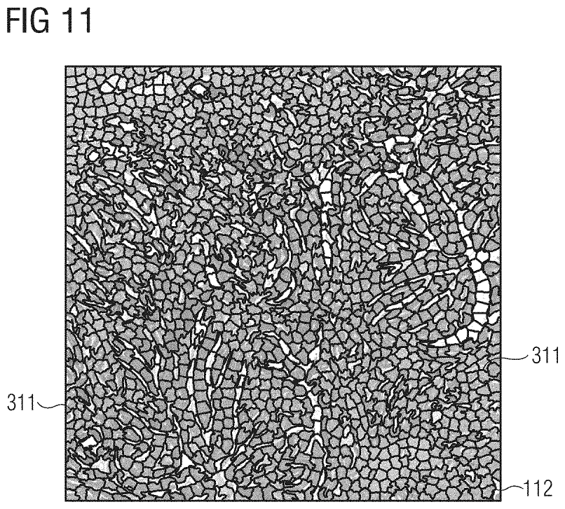

It is noted that the level of detail of the CAM can be larger than the level of detail of the classification result that is provided by the classification algorithm (cf. FIG. 9 where the classification result 211 is shown). Thus, while the level of detail of the class activation map still does not have the desired high value, can still be larger than the classification result of the classification algorithm.

Thus, to further increase the level of detail beyond the level of detail offered by the CAM, it is possible to rely on, both, the CAM as well as further features of the WSI that are extracted from the WSI. To give an example, it would be possible to consider color of the WSI pixel and/or contrast gradient of the WSI, as example features. Thus, image-level features of the WSI can be considered. The refined annotation can thus be determined based on such features and the CAM at box 3220.

By combining such image-level features of the whole slide image with the class activation map, it is possible to further increase the level of detail. For instance, variations of the class activation map can be correlated with variations of the image-level features; so that the level of detail corresponds to the length scale of the variation of the image-level features.

The features can be extracted as an unsupervised over-segmentation, such as Linear Spectral Clustering.

A partitioning or over-segmentation of the WSI would be possible. In other words, based on such features, it would be possible to determine multiple partitions of the WSI. For instance, it would be possible to determine partitions of the partitioning such that each partition of the partitioning includes a comparably small variation of respective features; for instance, each partition can include pixels of the whole slide image that do not have a significant variance in color or contrast. It would be possible that adjacent partitions are delimited at positions where the contrast gradient exceeds a certain threshold.

It is then possible to assign labels of the refined annotation to each partition of the partitioning, taking into account the CAM; so that the level of detail of the refined annotation corresponds to the level of detail of the partitioning. Thereby, the level of detail of the refined annotation can be increased beyond the level of detail of the class activation map.

Various options are available to determine such partitioning, e.g., depending on the particular choice of the features that govern the determination of the partitions. One specific example of such partitioning would be determination of super-pixels. In other words, the CAM is propagated to super-pixel level.

For instance, the features may be extracted to thereby obtain super-pixels of the WSI that have a common image contrast (cf. FIG. 10 where super-pixels 311 are shown for a certain part 112 of the WSI 111). Thus, super-pixels can be delimited along areas of a large contrast gradient of the pixel values of the WSI.

Then, to obtain the label of the refined annotation for a given super-pixel, it would be possible to determine the median of the CAM across those super-pixels. More generally, it would be possible that the refined annotation is determined based on a pooling of values of the CAM across the partitions of a partitioning, for each type of tissue.

In one scenario, such pooling—to obtain the label of the refined annotation for a given partition—could include an integration of the values of the CAM for a particular class over the area of individual partitions of the partitioning, e.g., across individual super-pixels. A class is assigned to each partition, e.g., super-pixel, based on the maximum integrand of individual classes. This equates to determining labels of the refined annotation.

Thus, in other words and summarizing, the initial annotation may be refined using a patch-based classification network. Patches are generated from the first annotation—cf. box 3110—by extracting image regions of certain size that contain a majority of mask pixels of one specific label of the initial annotation. That label is then essentially image-level for the given patch.

Optionally, a visual similarity of partitions, e.g., super-pixels, can be used to find a visually meaningful subset of partitions for each class, e.g., with graph-based methods.

Such techniques are based on the finding that a shape and number of the partitions control the shape of the labels of the second annotation, as well as their reliability. For example, one might choose roughly a quarter of the number of pixels in the CAM to get an averaging effect over the area of a given partition of the WSI. Note that the accuracy of the second annotation can be considerably higher even if the number of partitions is lower than the number of CAM pixels. This is because the fine contours of a larger clearly delineated area will be extracted, i.e., the contours follow the image content (the partitions are determined based on features of the image/the image content).

Next, such propagation of the CAM to super-pixel level is explained in practical terms: the class activation map could be seen as a low-resolution image. The super-pixels correspond to a partitioning wherein each super-pixel includes multiple pixels of the underlying image (and, as such, may be assumed to have a low-resolution); however, accordingly, the contours of the super-pixels are defined at a high resolution so that the super-pixels can capture a comparably high level of detail of the underlying image. Specifically, the label of the refined annotation defined for a given super-pixel can correspond to the class indicated by the class activation map for a given region that only covers a fraction of that given super-pixel; accordingly, a so-called “spill-out” effect can be observed where the majority class of the CAM in a given region also has an impact on areas surrounding that region, due to the geometry of the respective super-pixel. Partial-area effects that may otherwise result from the comparatively low resolution of the classification result of the classification algorithm or the comparatively low resolution of the class activation map of the classification algorithm may be avoided by making binary decisions for the label to be assigned to a given super-pixel, and by relying on the high-resolution pixel-level contours of the super-pixels. The practical explanations provided above also apply to other types of partitionings, other than super-pixels.

It would be optionally possible to filter labels of the refined annotation based on one or more predetermined criteria. For instance, for each super-pixel, it could be checked whether the super-pixel depicts tissue at all. Where there is no tissue, then it would be possible to assign a respective label, e.g., “background” label or at least a “non-tumor” type. For the CAM super-pixels, it would be possible to remove labels that pertain to “tumor cell” or annotate “no tumor cell”.

Specifically, by using such techniques once the classification algorithm has been trained in box 3205 based on the initial annotation, it is possible to determine the CAM in box 3210 even for fractions of the WSI for which no labels of the initial annotation are available. Thus, image regions of the WSI for which the CAM is determined can be at least partially outside the fraction of the WSI that is covered by the first annotation.

Thus, the second annotation can include fractions of the WSI that were not originally annotated in the first annotation. This is true because the initial patch-classification plus refinement model can be applied to areas that were not part of the initial training. A larger portion of the WSIs can this be used for training the ML segmentation algorithm

Summarizing, techniques have been disclosed that can be built into a standard ML segmentation algorithm as a kind of “prior”. The disclosed refinement of a low-detail annotation to yield a refined high-detail annotation can be understood as a filter on the input training data during training of any supervised ML segmentation algorithms. Thus, this may be referred to as “shape prior” for the annotation.

Further summarizing, specifically techniques have been described of using an annotation protocol for defining labels of a first annotation as exclusive and tight regions but only up to a certain accuracy (scale). The first annotation may only include labels for some regions of a WSI, but not the entire WSI. The first annotation can thus have a defined accuracy at a scale that makes the task feasible and maximizes variability; i.e., partially annotating many WSIs rather than a few WSIs completely.

Then, the first annotation can be refined using a patch classification provided by a classification algorithm. Thereby, a second annotation of the WSI is obtained and can be used as ground truth for setting parameters of an ML segmentation algorithm.

In some scenarios, such refinement of the first annotation is based on a CAM, to obtain a higher level of detail if compared to the first annotation, i.e., a larger spatial resolution than patch size of patches on which the classification algorithm operates.

To address the still comparatively low level of detail of the CAM, it is possible to incorporate local image information such as gradient of the WSI. For example, it would be possible to use an unsupervised over-segmentation of the WSI, such as super-pixels or another partitioning. The refined, second annotation can then be obtained at a level of detailed defined by the feature size of the partitions of the partitioning.

An ML segmentation algorithm that is trained based on the refined, second annotation can then be used in inference, i.e., to make prediction without ground truth being available.

The disclosed techniques are based on the finding that for some tasks—e.g., estimating tumor content in percent—the level of detail of the initial, first annotation may suffice; but that there are other tasks—e.g., detection and delineation of a tumor—that require higher level of detail for the ground truth.

In addition, or alternative, to that discussed herein, it will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been shown and described with respect to certain example embodiments, equivalents and modifications will occur to others skilled in the art upon the reading and understanding of the specification. The present invention includes all such equivalents and modifications and is limited only by the scope of the appended claims.

Although the present invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, while various examples have been disclosed in the context of training an ML segmentation algorithm in the context of digital pathology for processing WSIs, similar techniques may also be employed for other images. Specifically, use cases can benefit where comparably large images including a large amount of pixels, e.g., more than a million pixels or even more than 10,000,000 pixels are processed. Here, patch-wise week supervised training of an ML segmentation algorithm can be helpful. Examples would include aerial photography and satellite images, as well as telescope data.

What is claimed is:

1. A computer-implemented method of training a segmentation algorithm for digital pathology, the segmentation algorithm configured to segment a whole-slide image depicting tissue of multiple types, in accordance with the multiple types, wherein the computer-implemented method comprises:
obtaining the whole-slide image;
obtaining a first annotation of at least a part of the whole-slide image and for the multiple types, the first annotation having a first level of detail;
determining, based on the first annotation, a second annotation of the whole-slide image and for the multiple types, the second annotation having a second level of detail which is higher than the first level of detail; and
setting parameters of the segmentation algorithm based on the second annotation.

2. The computer-implemented method of claim 1, further comprising:
performing, based on the first annotation, a training of a classification algorithm configured to classify image regions of the whole-slide image in accordance with the multiple types; and
upon said performing of the training of the classification algorithm, using the classification algorithm to determine the second annotation.

3. The computer-implemented method of claim 2, further comprising:
determining class activation maps of the classification algorithm for the image regions of the whole-slide image, and
wherein the second annotation is determined based on the class activation maps.

4. The computer-implemented method of claim 3,
wherein the class activation maps have a third level of detail, which is smaller than the second level of detail.

5. The computer-implemented method of claim 3, further comprising:
extracting, at the second level of detail, features from the whole-slide image, and
wherein the second annotation is determined based on the features and the class activation maps.

6. The computer-implemented method of claim 5, further comprising:
determining, based on the features extracted from the whole-slide image, a partitioning of the whole-slide image,
wherein the second annotation is determined based on a combination of the partitioning and the class activation maps.

7. The computer-implemented method of claim 5,
wherein the features include at least one of a color or a contrast gradient.

8. The computer-implemented method of claim 6,
wherein the partitioning includes super-pixels of the whole-slide image.

9. The computer-implemented method of claim 6,
wherein the second annotation is determined based on a pooling of values of the class activation maps for each type across partitions of the partitioning.

10. The computer-implemented method of claim 3,
wherein the first annotation is restricted to a fraction of the whole-slide image,
wherein the image regions of the whole-slide image for which the class activation maps are determined are at least partially outside of the fraction of the whole-slide image.

11. The computer-implemented method of claim 2,
wherein any given image region of the whole-slide image having a label of the first annotation that is associated with a first type of the multiple types does not include tissue fractions of other types of the multiple types larger than a size threshold, and
wherein a length scale of the image regions corresponds to the size threshold.

12. The computer-implemented method of claim 1,
wherein the first annotation is restricted to a fraction of the whole-slide image, and
wherein the second annotation covers the whole-slide image.

13. The computer-implemented method of claim 1,
wherein the first annotation is obtained from a manual annotation process.

14. The computer-implemented method of claim 1,
wherein any given image region of the whole-slide image having a label of the first annotation that is associated with a first type of the multiple types does not include tissue fractions of other types of the multiple types beyond at least one of a quota or larger than a size threshold.

15. The computer-implemented method of claim 1, further comprising:
obtaining a further whole-slide image;
determining a segmentation result using the segmentation algorithm for the further whole-slide image; and
detecting, based on the segmentation result, tumor-type tissue in the further whole-slide image.

16. The computer-implemented method of claim 4, further comprising:
extracting, at the second level of detail, features from the whole-slide image,
wherein the second annotation is determined based on the features and the class activation map.

17. The computer-implemented method of claim 7,
wherein the second annotation is determined based on a pooling of values of the class activation maps for each type across partitions of the partitioning.

18. The computer-implemented method of claim 8,
wherein the second annotation is determined based on a pooling of values of the class activation maps for each type across partitions of the partitioning.

19. A non-transitory computer-readable storage medium storing computer-executable instructions that, when executed by at least one processor, cause the at least one processor to perform the computer-implemented method of claim 1.

20. A device for training a segmentation algorithm for digital pathology, the segmentation algorithm configured to segment a whole-slide image depicting tissue of multiple types, in accordance with the multiple types, wherein the device comprises:
at least one processor; and
at least one memory storing computer-executable instructions that, when executed at the least one processor, cause the device to obtain the whole-slide image,
obtain a first annotation of at least a part of the whole-slide image and for the multiple types, the first annotation having a first level of detail,
determine, based on the first annotation, a second annotation of the whole-slide image and for the multiple types, the second annotation having a second level of detail which is higher than the first level of detail, and
set parameters of the segmentation algorithm based on the second annotation.
